(19) United States
(12) Patent Application Publication
(10) Pub. No.: US 2019/0017892 A1
(43) Pub. Date: Jan. 17, 2019

(54) PRESSURE SENSOR, PRODUCTION METHOD FOR PRESSURE SENSOR, PRESSURE SENSOR MODULE, ELECTRONIC APPARATUS, AND VEHICLE

(71) Applicant: SEIKO EPSON CORPORATION, Tokyo (JP)

(72) Inventor: Hiroyuki SHIMADA, Chuo-shi (JP)

(73) Assignee: SEIKO EPSON CORPORATION, Tokyo (JP)

(21) Appl. No.: 16/025,178

(22) Filed: Jul. 2, 2018

(30) Foreign Application Priority Data
Jul. 13, 2017 (JP) 2017-137015

(51) Int. Cl. G01L 9/00

(52) U.S. Cl. CPC G01L 9/0052

(57) ABSTRACT

A pressure sensor includes a semiconductor substrate, an insulating layer which is placed on the semiconductor substrate and is provided with a cavity section, and a semiconductor layer which is placed on the insulating layer and includes a diaphragm that is placed so as to cover the cavity section. The diaphragm includes a through-hole which communicates with the cavity section.

### BACKGROUND

### 1. Technical Field

The present invention relates to a pressure sensor, a production method for a pressure sensor, a pressure sensor module, an electronic apparatus, and a vehicle.

### 2. Related Art

There has been known a configuration described in JP-A-2001-358345 (Patent Document 1) as a pressure sensor which detects a pressure. The pressure sensor described in Patent Document 1 includes a diaphragm which is flexurally deformed by receiving a pressure, a pressure reference chamber which is placed below the diaphragm, and a piezoresistive element which is placed on the upper surface of the diaphragm. This pressure sensor is formed from an SOI substrate obtained by bonding a first silicon substrate and a second silicon substrate through a silicon oxide film, and a glass substrate bonded to this SOI substrate. Specifically, the diaphragm is formed from the first silicon substrate, and the piezoresistive element is formed on the upper surface of the first silicon substrate. In the second silicon substrate, a through-hole is formed at a position overlapped with the diaphragm, and the pressure reference chamber is formed by bonding the glass substrate to the lower surface of the second silicon substrate so as to seal the through-hole.

However, in the pressure sensor described in Patent Document 1, it is necessary to form the piezoresistive element from the upper surface side of the SOI substrate and form a deep hole with a very high aspect ratio from the lower surface side of the SOI substrate, and it is difficult to ensure the alignment accuracy of these members. Therefore, it is necessary to ensure margin for alignment, and it is difficult to achieve miniaturization of the device. In addition, there is also a fear that the production time and cost for the device may increase.

### SUMMARY

An advantage of some aspects of the invention is to provide a pressure sensor which can be produced by a simple process and also can achieve miniaturization, a production method for the pressure sensor, a pressure sensor module, an electronic apparatus, and a vehicle.

Such an advantage can be achieved by the following configurations.

A pressure sensor according to an aspect of the invention includes a semiconductor substrate, an insulating layer which is placed on one surface of the semiconductor substrate and is provided with a cavity section, and a semiconductor layer which is placed on the opposite side to the semiconductor substrate of the insulating layer and includes a diaphragm that is placed so as to cover the cavity section.

According to this configuration, the pressure sensor which can be produced by a simple process and also can achieve miniaturization is realized.

In the pressure sensor according to the aspect of the invention, it is preferred that the diaphragm includes a through-hole which communicates with the cavity section, and has a sealing section which seals the through-hole.

According to this configuration, the cavity section can be easily formed.

In the pressure sensor according to the aspect of the invention, it is preferred that in a plan view of the semiconductor substrate, a plurality of through-holes are placed along the outer edge of the diaphragm.

According to this configuration, the shape of the diaphragm is easily made to correspond to the predetermined shape.

In the pressure sensor according to the aspect of the invention, it is preferred that the pressure sensor has a piezoresistive element placed in the diaphragm.

According to this configuration, a pressure can be detected with a simple configuration.

In the pressure sensor according to the aspect of the invention, it is preferred that the pressure sensor has an edge section which is placed on an inner circumferential surface facing the cavity section of the insulating layer and surrounds at least a part of the cavity section in a plan view of the semiconductor substrate.

According to this configuration, the shape of the diaphragm is more easily made to correspond to the predetermined shape.

In the pressure sensor according to the aspect of the invention, it is preferred that the semiconductor substrate contains silicon, the insulating layer contains silicon oxide, and the semiconductor layer contains silicon.

According to this configuration, for example, the semiconductor substrate, the insulating layer, and the semiconductor layer can be formed from an SOI substrate. Therefore, the configuration of the pressure sensor becomes simpler. In addition, the pressure sensor can be easily produced by a semiconductor process.

A production method for a pressure sensor according to an aspect of the invention includes preparing an SOI substrate which has a first silicon layer, a second silicon layer, and an oxide silicon layer located between the first silicon layer and the second silicon layer, placing a piezoresistive element on the second silicon layer, forming a through-hole which penetrates the second silicon layer in the thickness direction and faces the silicon oxide layer, forming a cavity section which is located between the first silicon layer and the second silicon layer and a diaphragm which faces the first silicon layer through the cavity section, includes the piezoresistive element, and is flexurally deformed by receiving a pressure by removing a part of the silicon oxide layer through the through-hole, and sealing the through-hole.

According to this configuration, the pressure sensor can be produced by a simple process, and miniaturization of the pressure sensor can be achieved.

In the production method for a pressure sensor according to the aspect of the invention, it is preferred that the sealing includes forming a sealing layer on the surface on the opposite side to the first silicon layer of the diaphragm and thinning the sealing layer.

According to this configuration, the through-hole can be sealed, and also the substantial thickness of the diaphragm can be prevented from becoming large.

In the production method for a pressure sensor according to the aspect of the invention, it is preferred that the sealing layer is formed by high-density plasma CVD.

According to this configuration, the through-hole can be more reliably sealed.

In the production method for a pressure sensor according to the aspect of the invention, it is preferred that the sealing layer contains silicon oxide.

According to this configuration, the difference in the thermal expansion coefficient between the sealing layer and the SOI substrate can be made small. Therefore, an internal stress generated by thermal expansion can be suppressed small.

A pressure sensor module according to an aspect of the invention includes the pressure sensor according to the aspect of the invention, and a package which houses the pressure sensor.

According to this configuration, the effect of the pressure sensor according to the aspect of the invention can be enjoyed, and therefore, a pressure sensor module having high reliability is obtained.

An electronic apparatus according to an aspect of the invention includes the pressure sensor according to the aspect of the invention.

According to this configuration, the effect of the pressure sensor according to the aspect of the invention can be enjoyed, and therefore, an electronic apparatus having high reliability is obtained.

A vehicle according to an aspect of the invention includes the pressure sensor according to the aspect of the invention.

According to this configuration, the effect of the pressure sensor according to the aspect of the invention can be enjoyed, and therefore, a vehicle having high reliability is obtained.

### BRIEF DESCRIPTION OF THE DRAWINGS

The invention will be described with reference to the accompanying drawings, wherein like numbers reference like elements.

FIG. 1 is a cross-sectional view showing a pressure sensor according to a first embodiment of the invention.

FIG. 2 is a plan view showing a diaphragm included in the pressure sensor shown in FIG. 1.

FIG. 3 is a plan view showing a modified example of the diaphragm shown in FIG. 2.

FIG. 4 is a view showing a bridge circuit including the sensor section shown in FIG. 2.

FIG. 5 is an enlarged cross-sectional view showing a release hole section of the diaphragm included in the pressure sensor shown in FIG. 1.

FIG. 6 is an enlarged cross-sectional view showing a modified example of a sealing section.

FIG. 7 is an enlarged cross-sectional view showing a modified example of the sealing section.

FIG. 8 is a flowchart showing production steps of the pressure sensor shown in FIG. 1.

FIG. 9 is a cross-sectional view for illustrating a production method for the pressure sensor shown in FIG. 1.

FIG. 10 is a cross-sectional view for illustrating the production method for the pressure sensor shown in FIG. 1.

FIG. 11 is a cross-sectional view for illustrating the production method for the pressure sensor shown in FIG. 1.

FIG. 12 is a plan view for illustrating the production method for the pressure sensor shown in FIG. 1.

FIG. 13 is an enlarged cross-sectional view for illustrating the production method for the pressure sensor shown in FIG. 1.

FIG. 14 is an enlarged cross-sectional view for illustrating the production method for the pressure sensor shown in FIG. 1.

FIG. 15 is an enlarged cross-sectional view for illustrating the production method for the pressure sensor shown in FIG. 1.

FIG. 16 is an enlarged cross-sectional view for illustrating the production method for the pressure sensor shown in FIG. 1.

FIG. 17 is an enlarged cross-sectional view for illustrating the production method for the pressure sensor shown in FIG. 1.

FIG. 18 is an enlarged cross-sectional view for illustrating the production method for the pressure sensor shown in FIG. 1.

FIG. 19 is a plan view showing a pressure sensor according to a second embodiment of the invention.

FIG. 20 is a cross-sectional view taken along the line A-A in FIG. 19.

FIG. 21 is a flowchart showing production steps of the pressure sensor shown in FIG. 19.

FIG. 22 is an enlarged cross-sectional view for illustrating a production method for the pressure sensor shown in FIG. 1.

FIG. 23 is an enlarged cross-sectional view for illustrating the production method for the pressure sensor shown in FIG. 1.

FIG. 24 is an enlarged cross-sectional view for illustrating the production method for the pressure sensor shown in FIG. 1.

FIG. 25 is an enlarged cross-sectional view for illustrating the production method for the pressure sensor shown in FIG. 1.

FIG. 26 is a cross-sectional view showing a pressure sensor module according to a third embodiment of the invention.

FIG. 27 is a perspective view showing an altimeter as an electronic apparatus according to a fourth embodiment of the invention.

FIG. 28 is a front view showing a navigation system as an electronic apparatus according to a fifth embodiment of the invention.

FIG. 29 is a perspective view showing a car as a vehicle according to a sixth embodiment of the invention.

### DESCRIPTION OF EXEMPLARY EMBODIMENTS

Hereinafter, a pressure sensor, a production method for a pressure sensor, a pressure sensor module, an electronic apparatus, and a vehicle according to the invention will be described in detail based on embodiments shown in the accompanying drawings.

### First Embodiment

First, a pressure sensor according to a first embodiment of the invention will be described.

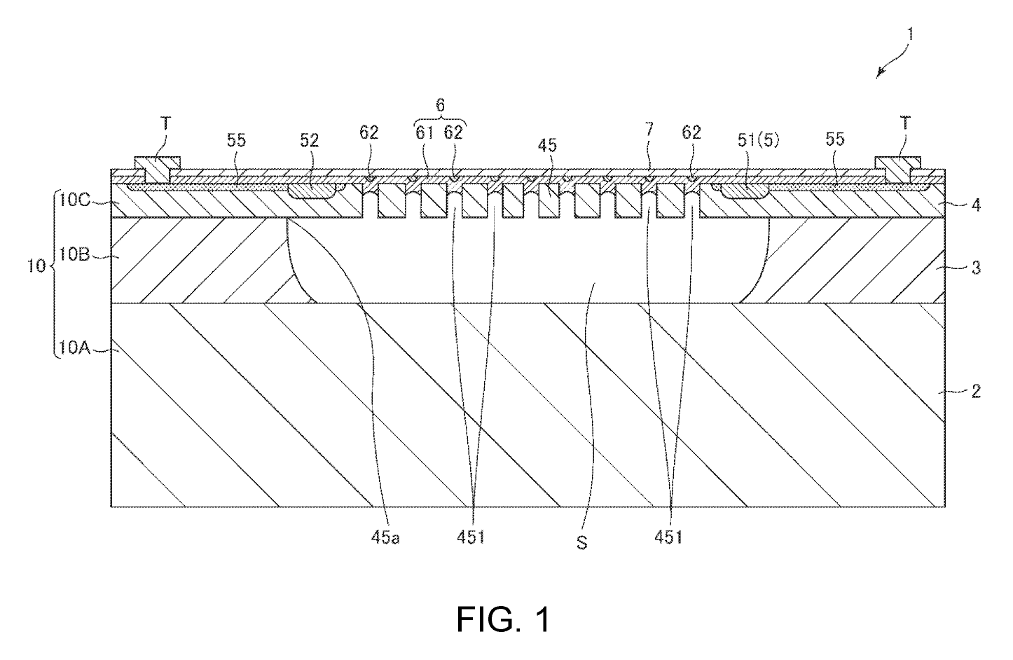

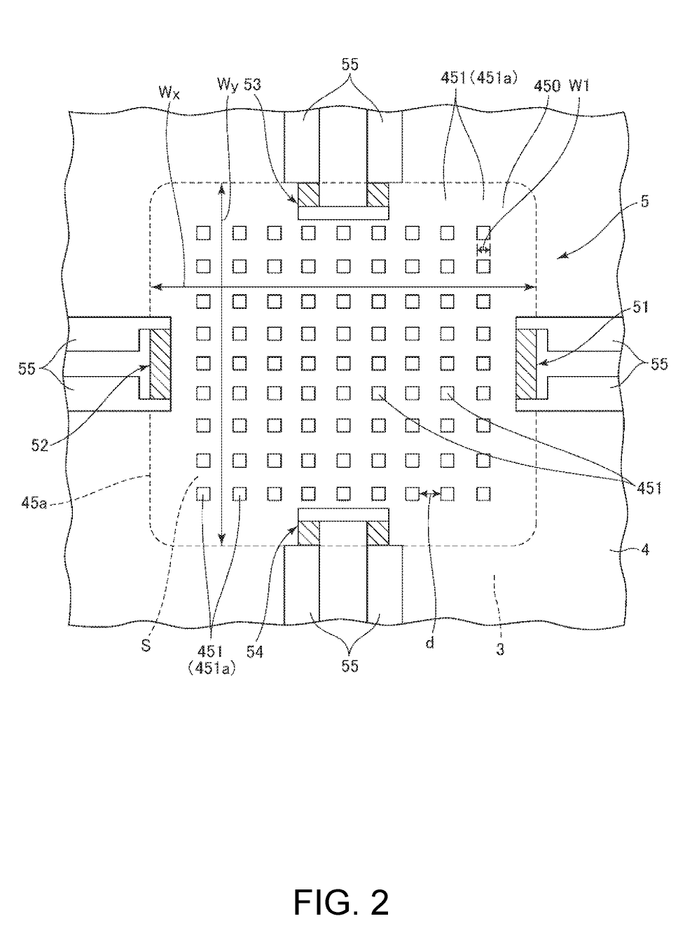

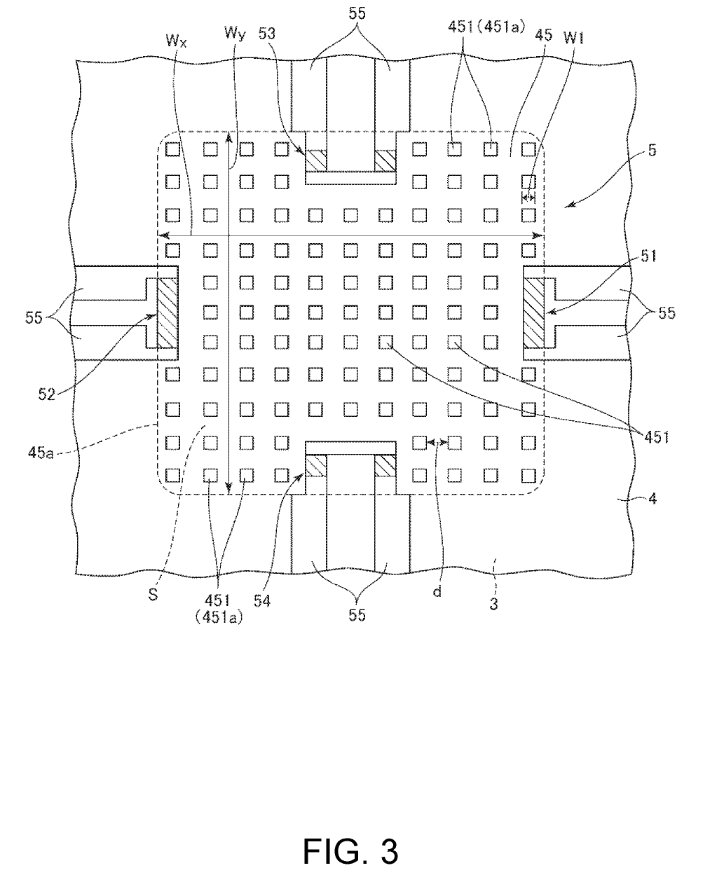

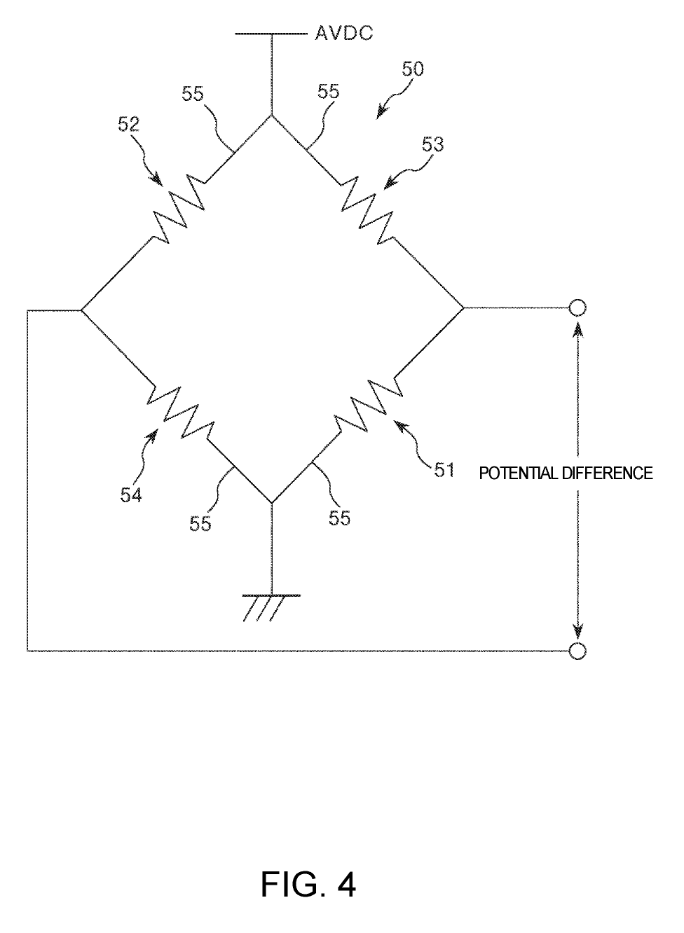

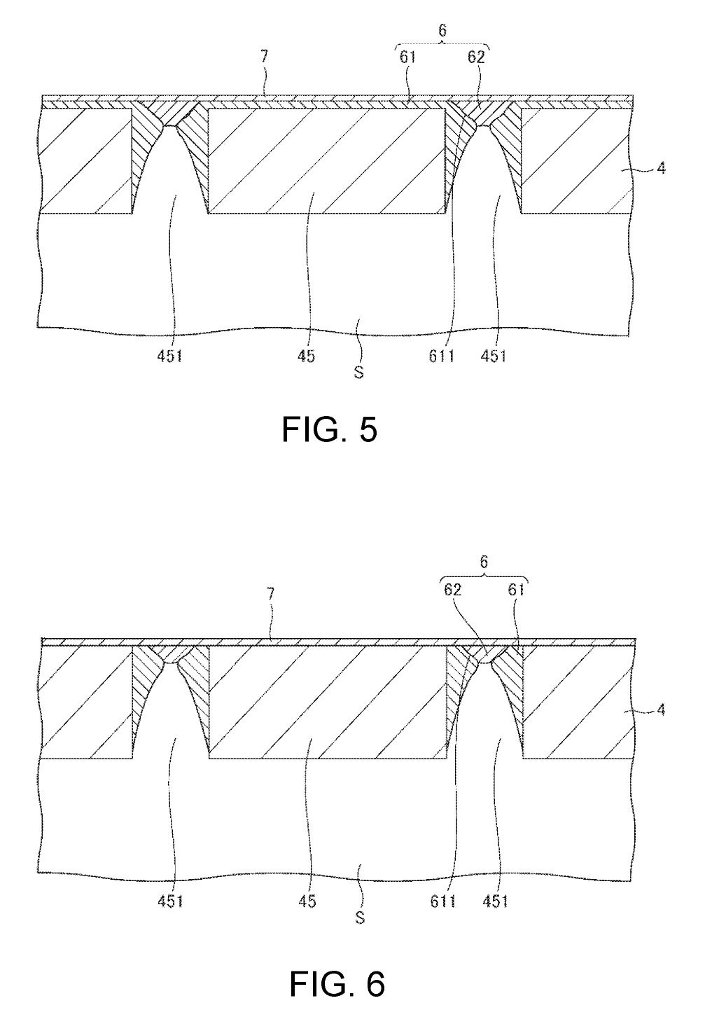

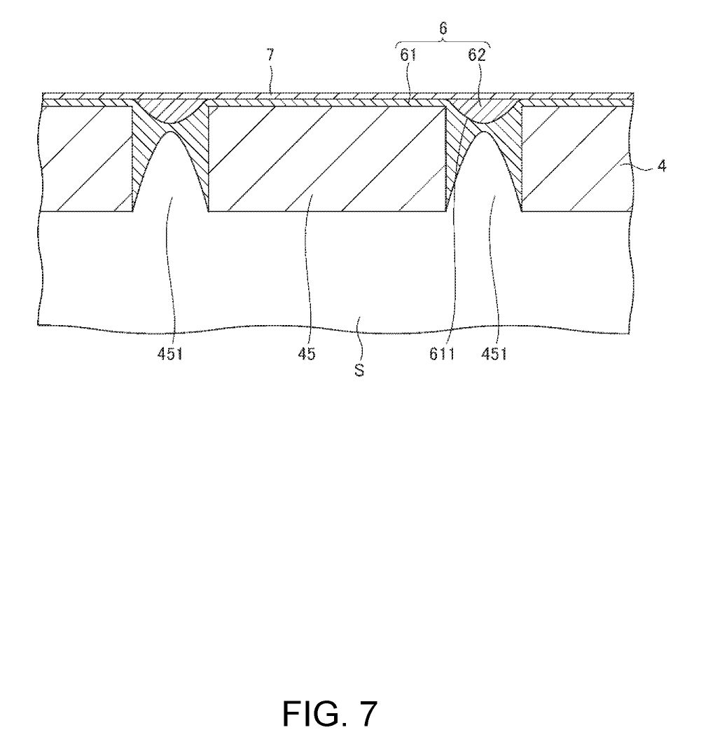

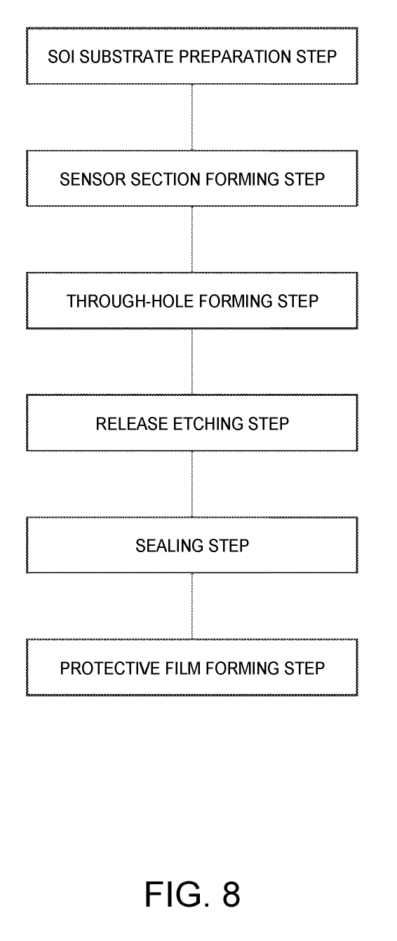

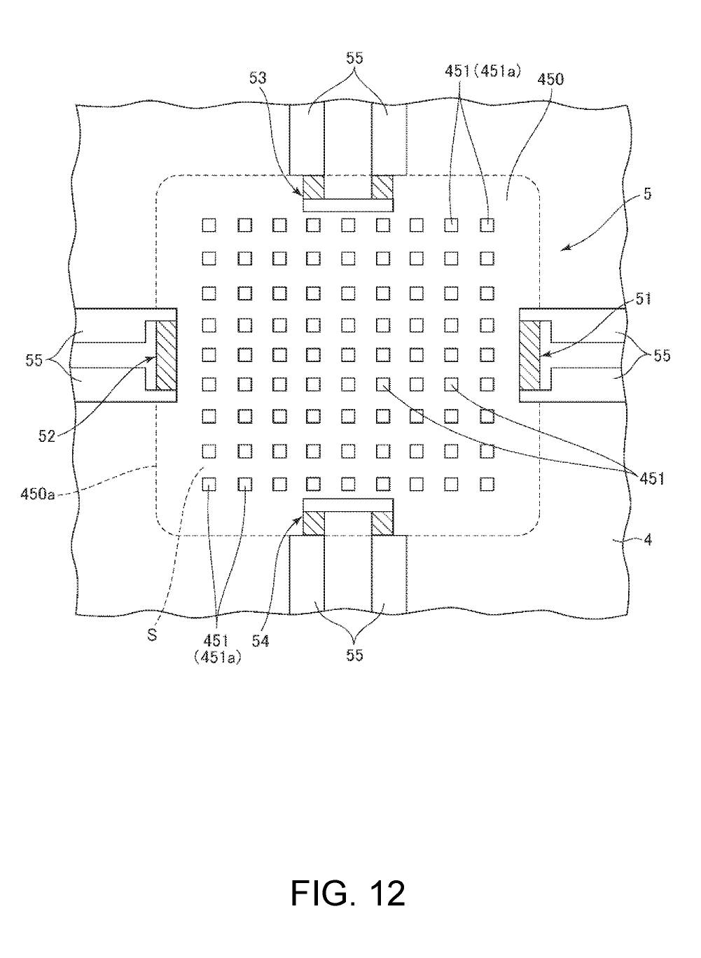

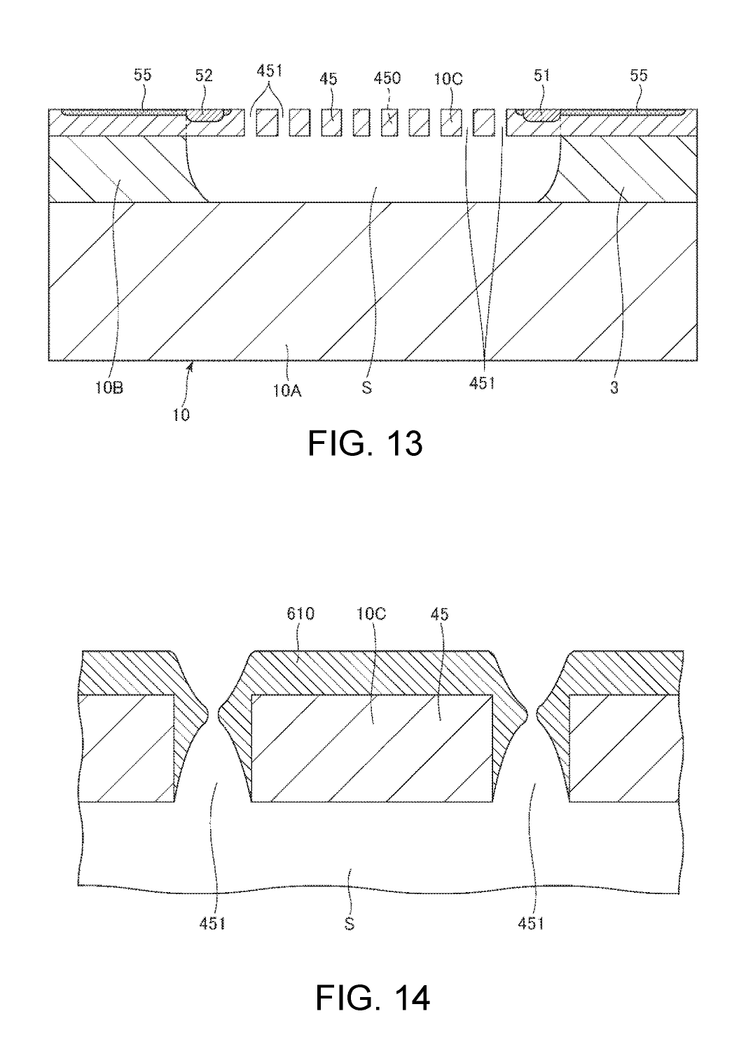

FIG. 1 is a cross-sectional view showing the pressure sensor according to the first embodiment of the invention. FIG. 2 is a plan view showing a diaphragm included in the pressure sensor shown in FIG. 1. FIG. 3 is a plan view showing a modified example of the diaphragm shown in FIG. 2. FIG. 4 is a view showing a bridge circuit including the sensor section shown in FIG. 2. FIG. 5 is an enlarged cross-sectional view showing a release hole section of the diaphragm included in the pressure sensor shown in FIG. 1. FIGS. 6 and 7 are each an enlarged cross-sectional view showing a modified example of a sealing section. FIG. 8 is a flowchart showing production steps of the pressure sensor shown in FIG. 1. FIGS. 9 to 11 are each a cross-sectional view for illustrating a production method for the pressure sensor shown in FIG. 1. FIG. 12 is a plan view for illustrating the production method for the pressure sensor shown in FIG. 1. FIGS. 13 to 18 are each an enlarged cross-sectional view for illustrating the production method for the pressure sensor shown in FIG. 1.

In the following description, in each of FIG. 1, FIGS. 5 to 7, FIGS. 9 to 11, and FIGS. 13 to 18, the upper side and the lower side are also referred to as “upper” and “lower”, respectively. Further, a plan view of an SOI substrate, that is, a plan view seen from the vertical direction in FIG. 1 is also simply referred to as “a plan view”. Further, in FIGS. 2 and 9, the illustration of a sealing section 6 and a protective film 7 is omitted.

As shown in FIG. 1, a pressure sensor 1 includes a substrate 2 (semiconductor substrate), a pressure reference chamber S as a cavity section which is located on the upper side of the substrate 2, a wall section 3 (insulating layer) in a frame shape which surrounds the pressure reference chamber S, a substrate 4 (semiconductor layer) which is located on the upper side of the wall section 3 and has a diaphragm 45 that is flexurally deformed by receiving a pressure, a sensor section 5 which is placed in the diaphragm 45, a sealing section 6 which seals a through-hole 451 formed in the diaphragm 45, a protective film 7 which is placed on the upper surface of the substrate 4, and a terminal T which is electrically connected to the sensor section 5. The wall section 3 is constituted by a material having a high etching selectivity for the substrate 2 and the substrate 4.

The substrate 2, the wall section 3, and the substrate 4 are integrally formed from an SOI (Silicon on Insulator) substrate 10. More specifically, the SOI substrate 10 is a substrate which has a first silicon layer 10A, a second silicon layer 10C located on the upper side of the first silicon layer 10A, and a silicon oxide layer 10B located between the first silicon layer 10A and the second silicon layer 10C, and the substrate 2 is formed from the first silicon layer 10A, the wall section 3 is formed from the silicon oxide layer 10B, and the substrate 4 is formed from the second silicon layer 10C. In this manner, by using the SOI substrate 10, the configuration of the pressure sensor 1 becomes simple, and the production thereof also becomes easy. However, the configuration is not limited thereto, and the substrate 2, the wall section 3, and the substrate 4 may not be formed from the SOI substrate 10, and for example, the substrates 2 and 4 may be formed from a substrate (semiconductor substrate) constituted by a semiconductor material other than silicon, for example, germanium, gallium arsenide, gallium arsenide phosphide, gallium nitride, silicon carbide, or the like.

The thickness of the substrate 2 is not particularly limited, but is preferably set to, for example 200 μm or more and 800 μm or less. According to this, while preventing excessive thickening of the pressure sensor 1, the rigidity of the pressure sensor 1 can be sufficiently enhanced, and thus, the pressure sensor 1 having high reliability is obtained.

The wall section 3 has a frame shape and surrounds the periphery of the pressure reference chamber S in a plan view. The wall section 3 functions as a spacer for forming the pressure reference chamber S between the substrate 2 and the substrate 4. The thickness of the wall section 3 is not particularly limited, but is preferably set to, for example 0.5 μm or more and 2 μm or less. According to this, while preventing excessive thickening of the pressure sensor 1, the pressure reference chamber S having a sufficient thickness is obtained. Further, by setting the thickness to the above-mentioned lower limit or more, the contact between the diaphragm 45 and the substrate 2 can be effectively suppressed, and a wide pressure measurement range can be ensured. In addition, by setting the thickness to the above-mentioned upper limit or less, when the diaphragm. 45 is excessively flexurally deformed, the diaphragm 45 and the substrate 2 come into contact with each other, whereby further deformation of the diaphragm 45 can be regulated, and thus, breakage of the diaphragm 45 can be prevented.

The substrate 4 is bonded to the upper surface of the wall section 3 so as to close the upper part opening of the pressure reference chamber S. A portion overlapped with the pressure reference chamber S of the substrate 4 (a portion facing the substrate 2 through the pressure reference chamber S) becomes the diaphragm 45 which is flexurally deformed by receiving a pressure. The upper surface of such a diaphragm 45 becomes a pressure receiving surface which receives a pressure. The thickness of the substrate 4 is not particularly limited, but is preferably set to, for example 0.5 μm or more and 2 μm or less. According to this, the diaphragm 45 which is easily flexurally deformed sufficiently while maintaining the mechanical strength is realized.

As shown in FIG. 2, the plan view shape of the diaphragm 45 is an approximate square in which each corner is chamfered. In this manner, by chamfering each corner, stress concentration on each corner when the diaphragm 45 is flexurally deformed can be reduced. Therefore, breakage of the diaphragm 45 can be effectively suppressed. However, the plan view shape of the diaphragm 45 is not particularly limited, and for example, each corner may not be chamfered, or the plan view shape may be a polygon other than a square (for example, a triangle, a pentagon, a hexagon, or the like), a circle, an ellipse, an irregular shape, or the like.

The width Wx and the width Wy of the diaphragm 45 are not particularly limited, however, each width is preferably, for example, 50 μm or more and 150 μm or less, more preferably μm or more and 100 μm or less. According to this, miniaturization of the pressure sensor 1 can be achieved. The width Wx and the width Wy may be different from each other.

In the diaphragm 45, a plurality of through-holes 451, each of which penetrates the diaphragm in the thickness direction and communicates with the pressure reference chamber S, are formed. As also described in the production method below, the plurality of through-holes 451 are release holes for removing a portion overlapped with the diaphragm 45 of the silicon oxide layer 10B, that is, a portion to become the pressure reference chamber S by etching. According to this, the diaphragm 45 can be released from the substrate 2 and also the pressure reference chamber S can be formed directly below the diaphragm 45 by a simple production method. In particular, by forming the through-holes 451 in the diaphragm 45, the silicon oxide layer 10B located directly below the diaphragm 45 can be more reliably removed, and thus, the diaphragm 45 can be more reliably released from the substrate 2 and also the pressure reference chamber S can be more reliably formed directly below the diaphragm 45.

In this embodiment, the plurality of through-holes 451 are arranged in a matrix substantially uniformly throughout the diaphragm 45 in a plan view (see FIG. 2). Therefore, the silicon oxide layer 10B located directly below the diaphragm can be more reliably removed uniformly. Further, a plurality of through-holes 451 are placed along the outer edge 45a of the diaphragm 45 in a plan view. In other words, among the plurality of through-holes 451, through-holes 451a located on the outermost circumference are placed along the outer edge 45a of the diaphragm 45, preferably along the entire circumference of the outer edge 45a. According to this, the silicon oxide layer 10B can be removed along the outer shape of the diaphragm 45, and thus, the diaphragm 45 having a desired shape can be more reliably formed.

The width W1 of each through-hole 451 is not particularly limited, but is preferably, for example, 0.5 μm or more and 2 μm or less, more preferably 0.6 μm or more and 1.0 μm or less. According to this, the through-hole 451 has a sufficient size for supplying an etching solution, and the silicon oxide layer 10B can be more reliably removed through the through-hole 451. In addition, an excessive increase in the size of the through-hole 451 can be prevented, and thus, it is also possible to suppress the decrease in the mechanical strength of the diaphragm 45. The width W1 may be different for each through-hole 451. For example, a configuration in which the width W1 of the through-hole 451 located near the outer edge 45a is larger than the width W1 of the through-hole 451 located in a central portion of the diaphragm 45 may be adopted.

The separation distance d between the adjacent through-holes 451 is not particularly limited, but is preferably, for example, about 5 μm or more and 10 μm or less. According to this, the through-holes 451 can be placed at a moderate density. Therefore, while sufficiently maintaining the mechanical strength of the diaphragm. 45, the silicon oxide layer 10B directly below the diaphragm 45 can be more reliably removed.

In this embodiment, the cross-sectional shape in a plan view of the through-hole 451 is a square, however, the cross-sectional shape of the through-hole 451 is not limited thereto, and may be any shape, for example, a polygon such as a rectangle other than a square, a triangle, or a pentagon, a circle, an oval, or the like. The arrangement of the through-holes 451 is not particularly limited, and may be, for example, an arrangement as shown in FIG. 3. In this embodiment, a plurality of through-holes 451 are arranged uniformly throughout the diaphragm 45, however, the arrangement is not limited thereto, and for example, sparseness and denseness may occur in the arrangement density of the through-holes 451. That is, the arrangement density of the through-holes 451 may be different in an outer circumferential portion and a central portion of the diaphragm 45. Further, in this embodiment, the plurality of through-holes 451 are placed along the outer edge of the diaphragm 45, however, the arrangement is not limited thereto, and the plurality of through-holes 451 may not be placed along the outer edge of the diaphragm 45.

In the diaphragm 45, a sensor section 5 capable of detecting a pressure which acts on the diaphragm 45 is provided. As shown in FIG. 2, the sensor section 5 has four piezoresistive elements 51, 52, 53, and 54 provided in the diaphragm 45. The piezoresistive elements 51, 52, 53, and 54 are electrically connected to one another through a wiring 55 and constitute a bridge circuit 50 (Wheatstone bridge circuit) shown in FIG. 4. To the bridge circuit 50, a drive circuit which supplies (applies) a drive voltage AVDC is connected. The bridge circuit 50 outputs a detection signal (voltage) in accordance with the change in the resistance value of the piezoresistive element 51, 52, 53, or 54 based on the flexure of the diaphragm 45. Due to this, a pressure received by the diaphragm 45 can be detected based on this output detection signal.

As shown in FIG. 2, the piezoresistive elements 51, 52, 53, and 54 are placed in an outer edge portion of the diaphragm 45. When the diaphragm 45 is flexurally deformed by receiving a pressure, a large stress is applied particularly to the outer edge portion in the diaphragm 45, and therefore, by placing the piezoresistive elements 51, 52, 53, and 54 in the outer edge portion, the above-mentioned detection signal can be increased, and thus, the pressure detection sensitivity is improved. The placement of the piezoresistive elements 51, 52, 53, and 54 is not particularly limited, and for example, the piezoresistive elements 51, 52, 53, and 54 may be placed across the outer edge of the diaphragm 45 or may be placed in a central portion of the diaphragm 45.

Each of the piezoresistive elements 51, 52, 53, and 54 is formed by, for example, doping (diffusing or injecting) an impurity such as phosphorus or boron into the substrate 4. The wiring 55 is formed by, for example, doping (diffusing or injecting) an impurity such as phosphorus or boron into the substrate 4 at a higher concentration than in the piezoresistive elements 51, 52, 53, and 54.

The configuration of the sensor section 5 is not particularly limited as long as it can detect a pressure received by the diaphragm 45. For example, a configuration in which at least one piezoresistive element which does not constitute the bridge circuit 50 is placed in the diaphragm 45 may be adopted.

As shown in FIG. 5, the sealing section 6 which seals the through-hole 451 of the diaphragm 45 has a first member 61 and a second member 62. In this embodiment, a configuration in which the through-hole 451 cannot be sealed only by the first member 61, and a gap formed in the first member 61 is sealed by the second member 62 is adopted. In this manner, by providing the second member 62 in addition to the first member 61, the through-hole 451 can be more reliably sealed. For example, in the case where the width of the through-hole 451 is relatively large, the configuration as shown in FIG. 5 is likely to be adopted.

The constituent material of the first member 61 is not particularly limited, but preferably includes, for example, silicon oxide (SiO₂), and in particular, in this embodiment, the first member 61 is constituted by silicon oxide. On the other hand, the constituent material of the second member 62 is not particularly limited, but preferably includes, for example, silicon, and in this embodiment, the second member 62 is constituted by CVD polysilicon (CVD-Poly-Si), with which airtightness is easily secured. By using such materials, the first member 61 and the second member 62 can be easily formed by a semiconductor process.

Here, the first member 61 has a layer shape (film shape) and is placed also on the upper surface of the substrate 4. According to this, the surface leakage and the interface states of the piezoresistive elements 51, 52, 53, and 54 are reduced, and thus, the occurrence of noise can be suppressed.

Hereinabove, the sealing section 6 has been described, however, the configuration of the sealing section 6 is not particularly limited as long as it can seal the through-hole 451, and for example, for all or part of the through-holes 451, the second member 62 may be omitted or another member may be added. Further, as shown in FIG. 6, the first member 61 may not be provided on the upper surface of the substrate 4. That is, the first member 61 may be substantially placed only inside the through-hole 451. According to this, the substantial thickness of the diaphragm 45 can be prevented from becoming large.

Further, as shown in FIG. 7, a configuration in which the through-hole 451 is sealed by the first member 61, and the sealing of the through-hole 451 is made more reliable by the second member 62 may be adopted. Specifically, the through-hole 451 is closed by the first member 61, but the thickness of a central portion of the first member 61 in the through-hole 451 is smaller than the thickness of an edge portion. Due to this, the central portion of the first member is likely to collapse, and there is a fear that the airtightness of the pressure reference chamber S cannot be maintained only by the first member 61. Therefore, the second member 62 is placed on the first member 61, more specifically, the second member 62 is filled in a recessed section 611 formed on the upper surface of the first member 61 so as to reinforce the central portion of the first member 61 by the second member 62, whereby the mechanical strength of the sealing section 6 is increased, and thus, the airtightness of the pressure reference chamber S can be more reliably maintained. It is also acceptable that the through-holes 451 which are not sealed by the first member 61 as shown in FIG. 5 and the through-holes 451 which are sealed by the first member 61 as shown in FIG. 7 are mixedly present.

The pressure reference chamber S is surrounded by the substrate 2, the wall section 3, and the substrate 4, and is a hermetically sealed space. The pressure in the pressure reference chamber S becomes the reference value of a pressure to be detected by the pressure sensor 1. In particular, the pressure reference chamber S is preferably in a vacuum state (for example, 10 Pa or less). According to this, the pressure sensor 1 can be used as an absolute pressure sensor which detects a pressure with reference to vacuum, and the pressure sensor 1 with high convenience is realized. However, the pressure reference chamber S may not be in a vacuum state as long as the pressure therein is kept constant and may be in a depressurized state (excluding vacuum) or in a pressurized state.

Further, as shown in FIG. 1, the pressure reference chamber S has a tapered shape in which the transverse cross-sectional area thereof gradually increases from the substrate 2 side to the substrate 4 side. In addition, the ratio of change in the transverse cross-sectional area of the pressure reference chamber S gradually decreases from the substrate 2 side to the substrate 4 side. However, the shape of the pressure reference chamber S is not particularly limited, and for example, the transverse cross-sectional area thereof may be substantially constant from the substrate 2 side to the substrate 4 side.

On the upper surface of the first member 61, the protective film 7 is provided. The protective film 7 has a function of protecting the sensor section 5 from dust, moisture, a gas, etc. The constituent material of such a protective film 7 is not particularly limited, however, silicon nitride (SiN) is used in this embodiment. According to this, the sensor section 5 can be more reliably protected from dust, moisture, a gas, etc.

Further, as shown in FIG. 1, on the upper surface of the protective film 7, the terminal T is provided. The terminal T penetrates the protective film 7 and is electrically connected to the wiring 55. According to this, electrical connection to the sensor section 5 can be easily achieved through the terminal T.

Hereinabove, the pressure sensor 1 has been described. As described above, this pressure sensor 1 includes the substrate 2 (semiconductor substrate), the wall section 3 (insulating layer) which is placed on one surface of the substrate 2 and is provided with the pressure reference chamber S (cavity section), and the substrate 4 (semiconductor substrate) which is placed on the opposite side to the substrate 2 of the wall section 3 and includes the diaphragm 45 that is disposed so as to cover the pressure reference chamber S. According to such a configuration, first of all, the pressure sensor 1 which is small and has high detection accuracy is obtained. Then, as also described in the production method below, the pressure sensor 1 can be produced only by processing from the upper surface side of the SOI substrate 10. Therefore, as compared with a configuration which requires processing of the SOI substrate from both surface sides as in the related art, the production step, production time, and production cost can be reduced. Further, it is not necessary to perform alignment between processing from the upper surface side of the SOI substrate and processing from the lower surface side thereof as in the related art, and therefore, it is not necessary to ensure margin for alignment, and thus, the size of the device can be reduced by that amount. In addition, the thickness of the substrate 2 can be sufficiently ensured, and therefore, the rigidity can be increased, and thus, the pressure sensor 1 having high reliability is obtained.

Further, as described above, in the pressure sensor 1, the diaphragm 45 includes the through-hole 451 which communicates with the pressure reference chamber S and has the sealing section 6 which seals the through-hole 451. According to this, as also described in the production method below, the pressure reference chamber S can be easily formed.

Further, as described above, in the pressure sensor 1, the plurality of through-holes 451 are placed along the outer edge 45a of the diaphragm 45 in a plan view of the substrate 2. According to this, as also described in the production method below, the shape of the diaphragm 45 is easily made to correspond to the predetermined shape. In addition, the silicon oxide layer 10B located on the lower side of the diaphragm 45 is also easily removed.

Further, as described above, the pressure sensor 1 has piezoresistive elements 51, 52, 53, and 54 placed in the diaphragm 45. According to this, a pressure received by the diaphragm 45 can be easily detected by a simple configuration.

In this manner, it can also be said that the pressure sensor 1 includes the substrate 2, the pressure reference chamber S as the cavity section which is located on the upper surface (one surface) side of the substrate 2, the wall section 3 in a frame shape which is provided so as to surround the pressure reference chamber S in a plan view of the substrate 2, and the through-hole 451 which is located on the opposite side to the substrate 2 with respect to the pressure reference chamber S and communicates with the pressure reference chamber S, and has the diaphragm 45 which is flexurally deformed by receiving a pressure, the sealing section 6 which seals the through-hole 451, and the piezoresistive elements 51, 52, 53, and 54 which are placed in the diaphragm 45.

Further, as described above, in the pressure sensor 1, the substrate 2 contains silicon (Si), the wall section 3 contains silicon oxide (SiO₂), and the diaphragm 45 contains silicon (Si). According to this, the substrate 2, the wall section 3, and the diaphragm 45 can be formed from the SOI substrate. Therefore, the configuration of the pressure sensor 1 becomes simpler. In addition, the pressure sensor 1 can be easily produced by a semiconductor process.

Next, a production method for the pressure sensor 1 will be described. As shown in FIG. 8, the production method for the pressure sensor 1 includes an SOI substrate preparation step, a sensor section forming step, a through-hole forming step, a release etching step, a sealing step, and a protective film forming step.

### SOI Substrate Preparation Step

First, as shown in FIG. 9, an SOI substrate 10 is prepared. The SOI substrate 10 is a substrate which has a first silicon layer 10A, a second silicon layer 10C located on the upper side of the first silicon layer 10A, and a silicon oxide layer 10B located between the first silicon layer 10A and the second silicon layer 10C.

### Sensor Section Forming Step

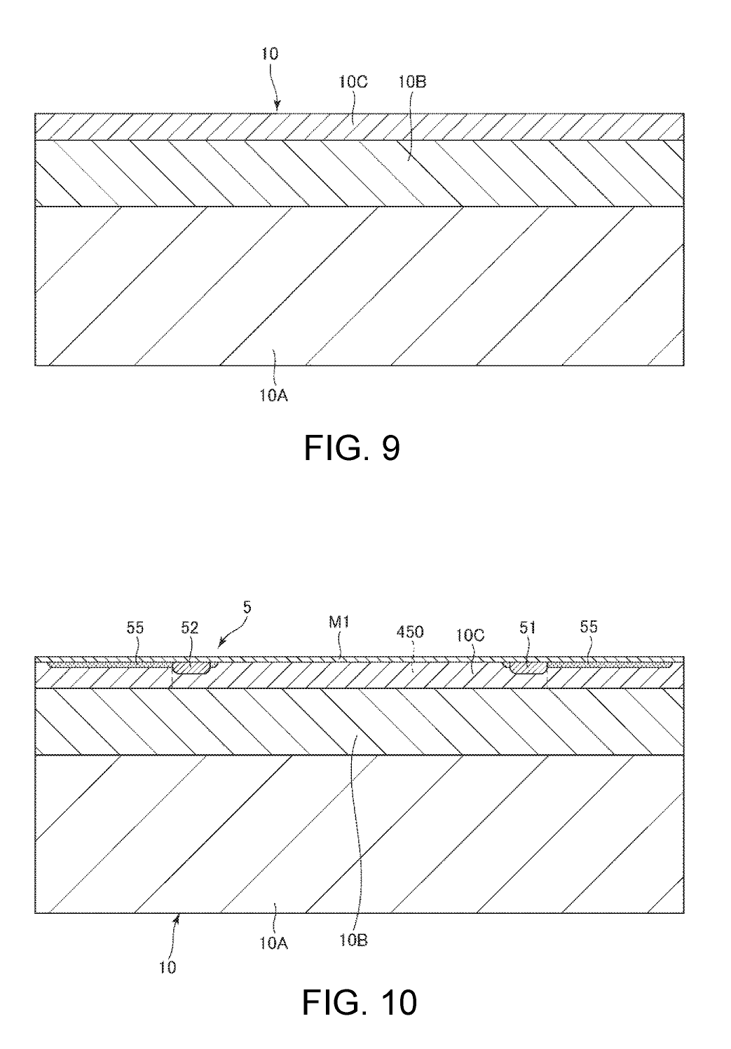

Subsequently, as shown in FIG. 10, a silicon oxide film M1 is formed on the upper surface of the SOI substrate 10 (the upper surface of the second silicon layer 10C). The film forming method for the silicon oxide film M1 is not particularly limited, and for example, a method in which the upper surface of the SOI substrate 10 is thermally oxidized can be used. Subsequently, by injecting an impurity such as phosphorus or boron into the upper surface of the second silicon layer 10C, a sensor section 5 (piezoresistive elements 51, 52, 53, and 54, and a wiring 55) is formed.

### Through-Hole Forming Step

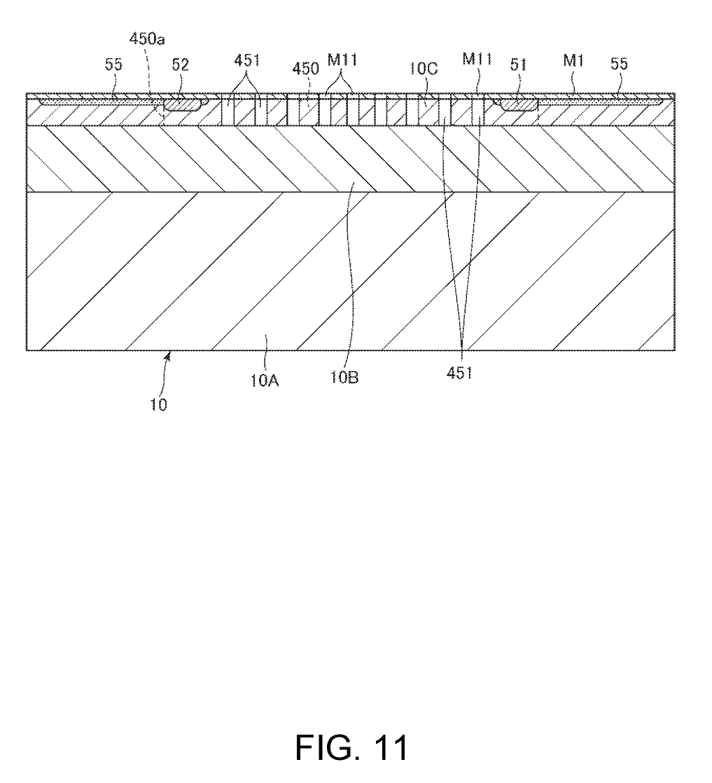

Subsequently, as shown in FIG. 11, the silicon oxide film M1 is patterned using a photolithographic technique and an etching technique, whereby openings M11 corresponding to a plurality of through-holes 451 are formed. Subsequently, the second silicon layer 10C is subjected to anisotropic etching through the silicon oxide film M1, whereby a plurality of through-holes 451 are formed. Of course, gas-phase etching with hydrogen fluoride vapor (HF vapor) may be performed for suppressing sticking of the diaphragm 45 or the like. Here, the plurality of through-holes 451 are formed in a diaphragm forming region 450 which becomes the diaphragm 45 later. Further, as shown in FIG. 12, the plurality of through-holes 451 are arranged substantially uniformly throughout the diaphragm forming region 450. In addition, among the plurality of through-holes 451, through-holes 451a located on the outermost circumference are placed along the outer edge 450a of the diaphragm forming region 450.

### Release Etching Step

Subsequently, the SOI substrate 10 is exposed to an etching solution such as buffered hydrofluoric acid. By doing this, as shown in FIG. 13, a portion located below the diaphragm forming region 450 of the silicon oxide layer 10B is removed by etching through the plurality of through-holes 451. In this manner, a pressure reference chamber S is formed below the diaphragm forming region 450 and a wall section 3 in a frame shape is formed therearound. Further, by the pressure reference chamber S, the diaphragm forming region 450 is released from the silicon oxide layer 10B, and a portion overlapped with the pressure reference chamber S becomes the diaphragm 45.

As described above, the plurality of through-holes 451 are arranged substantially uniformly throughout the diaphragm forming region 450. Therefore, the silicon oxide layer 10B located below the diaphragm forming region 450 can be more reliably removed in a shorter time. Further, as described above, some (451a) of the plurality of through-holes 451 are placed along the outer edge 450a of the diaphragm forming region 450. Due to this, the silicon oxide layer 10B is removed according to the shape of the diaphragm forming region 450, and therefore, the diaphragm 45 having a desired shape (or a shape close to a desired shape) can be more reliably obtained.

### Sealing Step

Subsequently, as shown in FIG. 14, on the upper surface of the second silicon layer 10C, a first sealing film 610 is formed. By the first sealing film 610, the respective through-holes 451 are sealed. In this embodiment, the through-holes 451 are not completely sealed by the first sealing film 610, and a gap which communicates with the pressure reference chamber S is formed in the first sealing film 610. The constituent material of the first sealing film 610 is not particularly limited, however, silicon oxide (SiO₂) is used in this embodiment. In this manner, by using a silicon (Si)-based material as the material of the first sealing film 610, the difference in the thermal expansion coefficient between the first sealing film 610 and the SOI substrate 10 can be made small. Therefore, a thermal stress to be applied to the diaphragm 45 or the like can be suppressed small. That is, the temperature sensitivity of the pressure sensor 1 can be suppressed, and highly accurate pressure measurement can be achieved.

The film forming method for the first sealing film 610 is not particularly limited, and for example, various film forming methods (vapor deposition methods) such as a sputtering method and a CVD method can be used. Among these, in particular, it is preferred to use an unconformal film forming method as the film forming method for the first sealing film 610. According to this, as compared with the case where a conformal film forming method is used, the first sealing film 610 is likely to grow toward the center of the through-hole 451 in the through-hole 451. Due to this, the through-hole 451 can be more reliably sealed by the first sealing film 610. The unconformal film forming method is not particularly limited, but it is preferred to use a high-density plasma CVD (HDP-CVD) method. According to this, by appropriately setting various conditions, the unconformal film forming method can be easily realized.

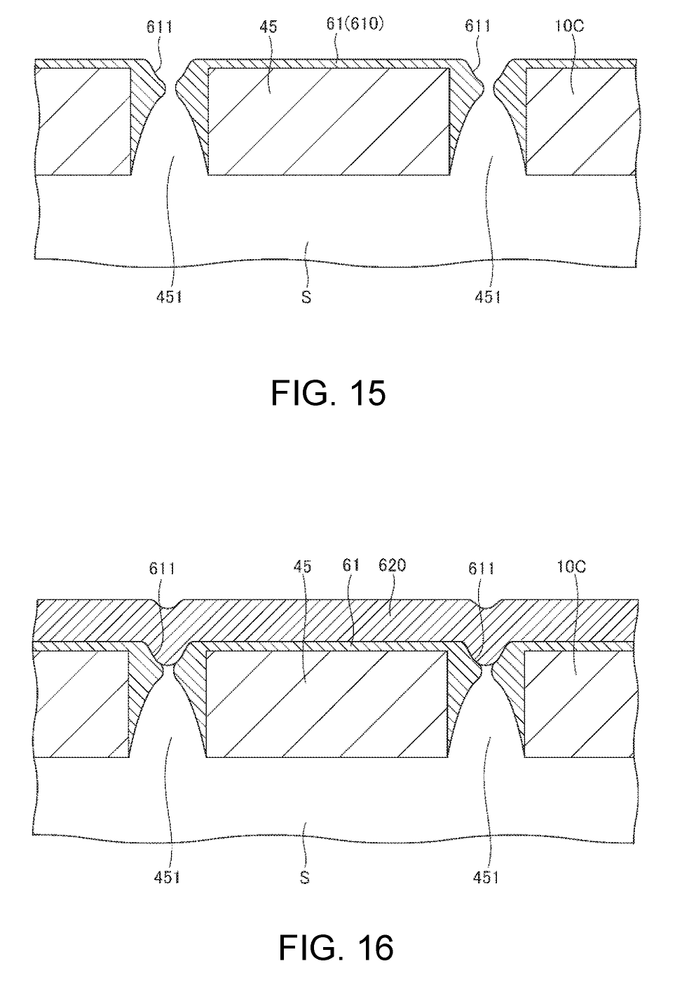

Subsequently, as shown in FIG. 15, the first sealing film 610 is thinned (etched back). By doing this, a first member 61 is obtained. By thinning the first sealing film 610, the substantial thickness of the diaphragm 45 can be prevented from becoming large. Further, by leaving the first sealing film 610 thin on the upper surface of the second silicon layer 10C, the surface leakage and the interface states of the piezoresistive elements 51, 52, 53, and 54 are reduced, and thus, the occurrence of noise can be suppressed. The method for thinning the first sealing film 610 is not particularly limited, and for example, plasma etching can be used.

Subsequently, as shown in FIG. 16, on the upper surface of the first member 61, a second sealing film 620 is formed. As described above, a central portion of the first member 61 cannot sometimes be made sufficiently thick, or the through-hole 451 cannot sometimes be sealed only by the first member 61. In particular, in this embodiment, the through-hole 451 cannot be sealed by the first member 61. Therefore, by further forming the second sealing film 620 on the first member 61, the through-hole 451 can be more reliably sealed by the first member 61 and the second sealing film 620.

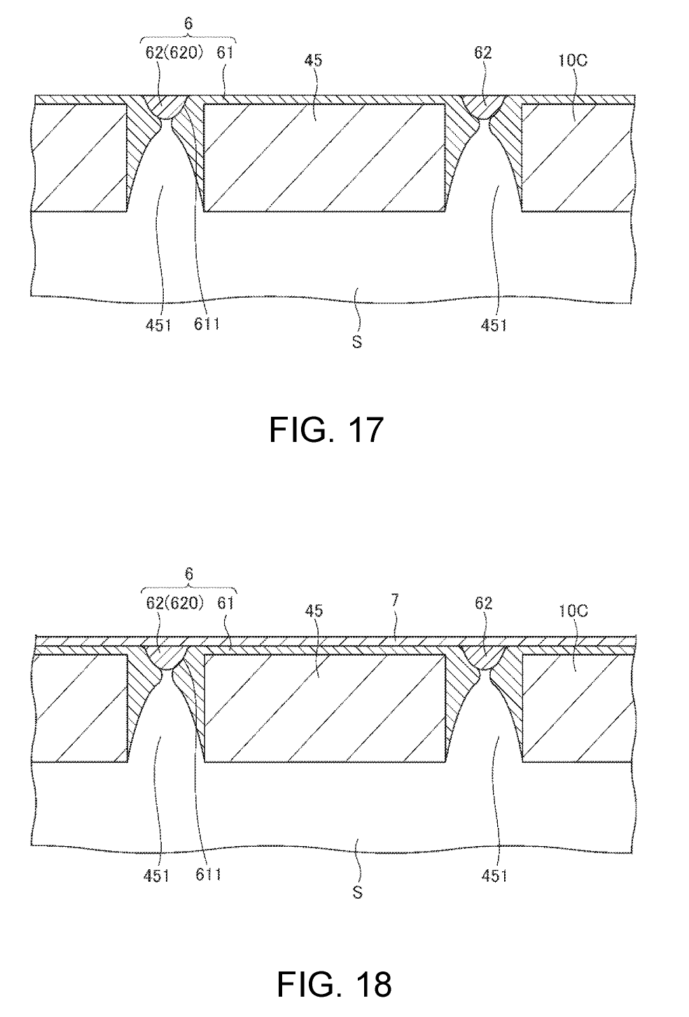

Subsequently, as shown in FIG. 17, the second sealing film 620 is thinned (etched back), whereby the upper surface of the first member 61 is exposed, and a portion other than the portion overlapped with the through-hole 451 (a portion filled in a recessed section 611 and is used for sealing the through-hole 451) is substantially removed. By doing this, a second member 62 is obtained, and a sealing section 6 composed of the first member 61 and the second member 62 is formed. By thinning the second sealing film 620, the substantial thickness of the diaphragm 45 can be prevented from becoming large.

### Protective Film Forming Step

Subsequently, as shown in FIG. 18, a protective film 7 is formed on the sealing section 6. The constituent material of the protective film 7 is not particularly limited, however, silicon nitride (SiN) is used in this embodiment. According to this, by the protective film 7, the pressure sensor 1 can be effectively protected from dust, moisture, etc. The film forming method for the protective film 7 is not particularly limited, and for example, various film forming methods (vapor deposition methods) such as a sputtering method and a CVD method can be used.

Subsequently, a terminal T which penetrates the protective film 7 and the sealing section 6 and is electrically connected to the wiring 55 is formed. As described above, the pressure sensor 1 is obtained.

Hereinabove, the production method for the pressure sensor 1 has been described. As described above, the production method for the pressure sensor 1 includes a step of preparing the SOI substrate 10 which has the first silicon layer 10A, the second silicon layer 10C, and the silicon oxide layer 10B located between the first silicon layer 10A and the second silicon layer 10C, a step of placing the piezoresistive elements 51, 52, 53, and 54 on the second silicon layer 10C, a step of forming the through-holes 451 which penetrate the second silicon layer 10C in the thickness direction and face the silicon oxide layer 10B, a step of forming the pressure reference chamber S as the cavity section which is located between the first silicon layer 10A and the second silicon layer 10C and the diaphragm 45 which faces the first silicon layer 10A through the pressure reference chamber S, includes the piezoresistive elements 51, 52, 53, and 54, and is flexurally deformed by receiving a pressure by removing a part of the silicon oxide layer 10B through the through-holes 451, and a step of sealing the through-holes 451. According to such a production method, the pressure sensor 1 can be produced only by processing from the upper surface side of the SOI substrate 10. Therefore, as compared with a configuration which requires processing of the SOI substrate from both surface sides as in the related art, the production step, production time, and production cost can be reduced. Further, it is not necessary to perform alignment between processing from the upper surface side of the SOI substrate and processing from the lower surface side thereof as in the related art, and therefore, it is not necessary to ensure margin for alignment, and thus, the size of the pressure sensor 1 can be reduced by that amount. In addition, the thickness of the substrate 2 can be sufficiently ensured, and therefore, the rigidity can be increased, and thus, the pressure sensor 1 having high reliability is obtained.

Further, as described above, in the production method for the pressure sensor 1, the sealing step includes a step of forming the first sealing film 610 as the sealing layer on the upper surface of the diaphragm 45 (the surface on the opposite side to the first silicon layer 10A) and a step of thinning the first sealing film 610. According to this, the through-holes 451 can be sealed, and also the substantial thickness of the diaphragm 45 can be prevented from becoming large.

Further, as described above, in the production method for the pressure sensor 1, the first sealing film 610 is formed by high-density plasma CVD. According to this, the through-holes 451 can be more reliably sealed by the first sealing film 610.

Further, as described above, in the production method for the pressure sensor 1, the first sealing film 610 contains silicon oxide (SiO₂). According to this, the difference in the thermal expansion coefficient between the first sealing film 610 and the SOI substrate can be made small. Therefore, an internal stress generated by thermal expansion can be suppressed small, and the occurrence of cracking in the sealing section 6 or the formation of a gap at the boundary between the sealing section 6 and the through-hole 451 can be effectively suppressed, and thus, the airtightness of the pressure reference chamber S can be more effectively maintained. Moreover, a change in the internal stress to be applied to the diaphragm 45 due to the environmental temperature can be suppressed, and thus, the drift of the output can also be reduced.

### Second Embodiment

Next, a pressure sensor according to a second embodiment of the invention will be described.

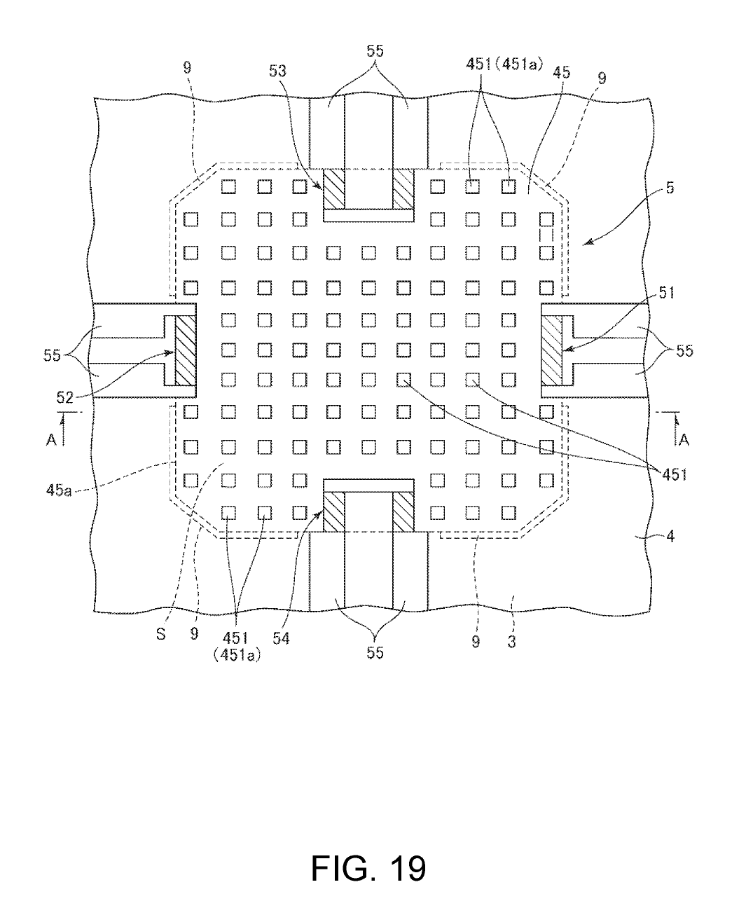

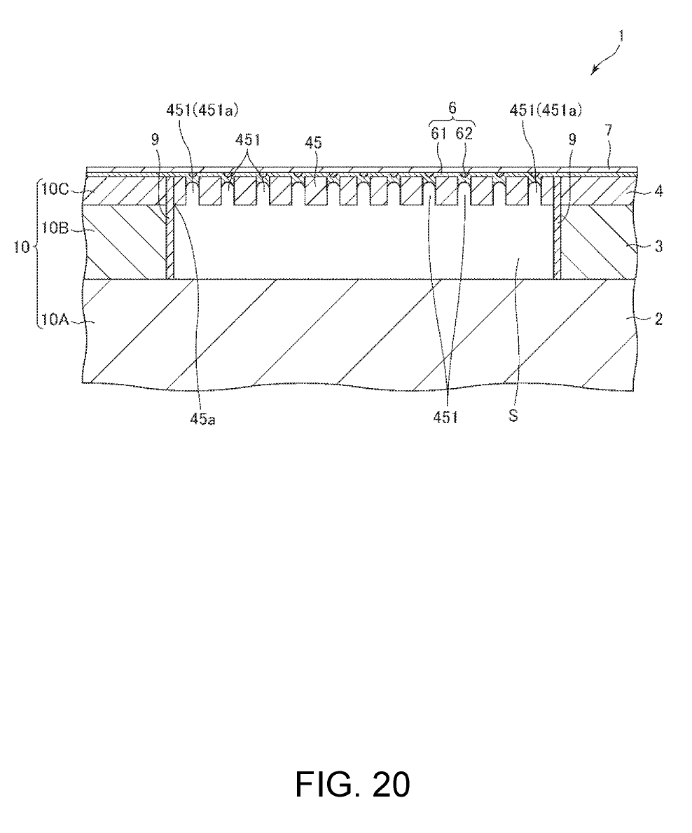

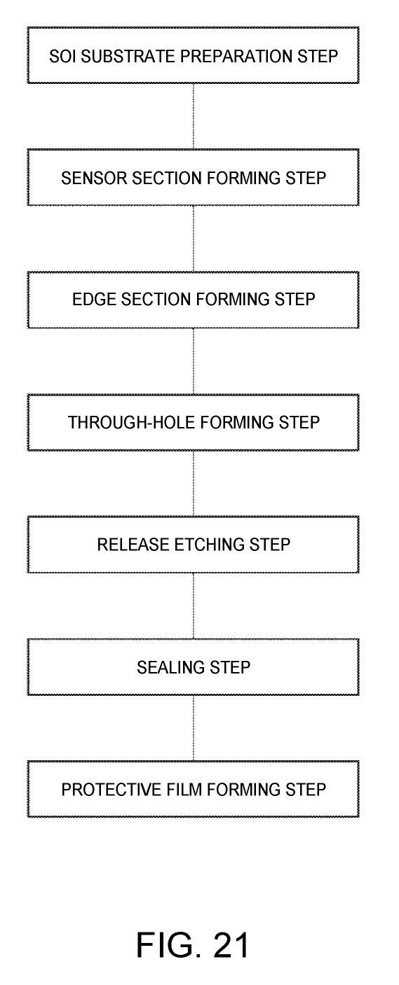

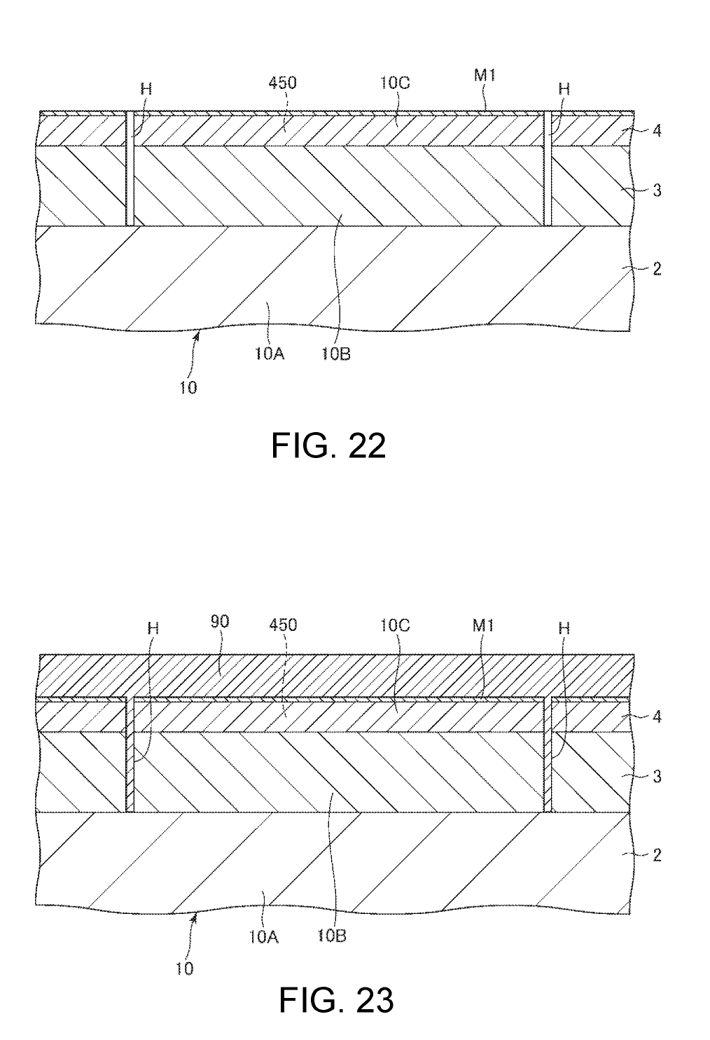

FIG. 19 is a plan view showing the pressure sensor according to the second embodiment of the invention. FIG. 20 is a cross-sectional view taken along the line A-A in FIG. 19. FIG. 21 is a flowchart showing production steps of the pressure sensor shown in FIG. 19. FIGS. 22 to 25 are each an enlarged cross-sectional view for illustrating a production method for the pressure sensor shown in FIG. 1. In FIG. 19, the illustration of a sealing section 6 and a protective film 7 is omitted.

A pressure sensor 1 according to this embodiment is substantially the same as the pressure sensor 1 according to the first embodiment described above except that the pressure sensor 1 has an edge section 9 placed on the inner wall of a wall section 3.

Hereinafter, with respect to the pressure sensor 1 according to the second embodiment, different points from the above-mentioned first embodiment will be mainly described, and the description of the same matter will be omitted. The same components as those of the above-mentioned embodiment are denoted by the same reference numerals.

As shown in FIGS. 19 and 20, the pressure sensor 1 according to this embodiment has an edge section 9 placed on the inner circumferential surface of a wall section 3. The edge section 9 is placed so as to surround at least a part of the pressure reference chamber S avoiding a sensor section 5 in a plan view of a substrate 2. In particular, in this embodiment, the edge section 9 is placed at least at each corner on the inner circumferential surface of the wall section 3. Such an edge section 9 functions as an etching stopper when forming the pressure reference chamber S by removing a silicon oxide layer 10B in a release etching step. Due to this, for example, as compared with the above-mentioned first embodiment in which an etching stopper is not included, the pressure reference chamber S and the diaphragm 45 are more easily formed into a desired shape. The placement of the edge section 9 is not particularly limited, however, the edge section 9 is preferably placed in a range as wide as possible avoiding the sensor section 5. According to this, the above-mentioned effect is more effectively exhibited.

In this embodiment, the edge section 9 is placed penetrating the second silicon layer 10C. Therefore, in a release etching step, an etching solution is less likely to seep to the outside of the edge section 9. Accordingly, the pressure reference chamber S and the diaphragm 45 can be more reliably formed into a desired shape. The edge section 9 is placed penetrating the second silicon layer 10C in this manner, and therefore, the edge section 9 is placed avoiding the sensor section 5. Due to this, the placement of the sensor section 5 is not inhibited.

The constituent material of the edge section 9 is not particularly limited, however, CVD polysilicon (CVD-Poly-Si) is used in this embodiment. By using a silicon (Si)-based material as the material of the edge section 9 in this manner, the difference in the thermal expansion coefficient between the edge section 9 and the SOI substrate 10 can be made small. Therefore, a thermal stress to be applied to the diaphragm 45 or the like can be suppressed small. That is, the temperature sensitivity of the pressure sensor 1 can be suppressed, and highly accurate pressure measurement can be achieved.

In this manner, the pressure sensor 1 according to this embodiment has the edge section 9 which is placed on the inner circumferential surface of the wall section 3 and surrounds at least a part of the pressure reference chamber S in a plan view of the substrate 2. According to this, for example, as compared with the above-mentioned first embodiment in which the edge section 9 is not included, the pressure reference chamber S and the diaphragm 45 can be more easily formed into a desired shape.

Next, a production method for the pressure sensor 1 according to this embodiment will be described. As shown in FIG. 21, the production method for the pressure sensor 1 according to this embodiment includes an SOI substrate preparation step, a sensor section forming step, an edge section forming step, a through-hole forming step, a release etching step, a sealing step, and a protective film forming step.

### SOI Substrate Preparation Step and Sensor Section Forming Step

The SOI substrate preparation step and the sensor section forming step are the same as in the production method described in the above-mentioned first embodiment. Therefore, the description of these steps will be omitted.

### Edge Section Forming Step

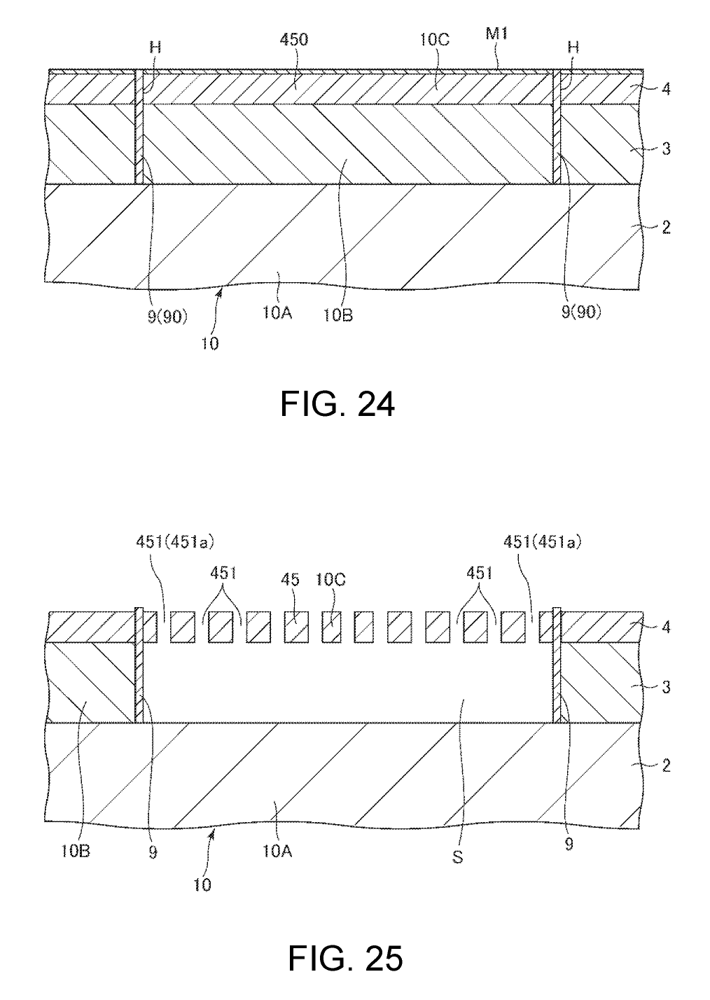

First, as shown in FIG. 22, along the outer edge of a diaphragm forming region 450, a through-hole H which penetrates a silicon oxide film M1, a second silicon layer 10C, and a silicon oxide layer 10B is formed. Subsequently, as shown in FIG. 23, an edge section forming layer 90 is formed from the silicon oxide film M1 side, whereby the through-hole H is buried in the edge section forming layer 90. Subsequently, as shown in FIG. 24, a portion stacked on the upper surface of the silicon oxide film M1 of the edge section forming layer 90 is removed by etching back. By doing this, only a portion filled in the through-hole H of the edge section forming layer 90 substantially remains, and an edge section 9 is formed by the portion.

The film forming method for the edge section forming layer 90 is not particularly limited, and for example, various film forming methods (vapor deposition methods) such as a sputtering method and a CVD method can be used. The constituent material of the edge section forming layer 90 is not particularly limited, however, polysilicon (Poly-Si) is used in this embodiment. By using a silicon (Si)-based material as the material of the edge section forming layer 90 in this manner, the difference in the thermal expansion coefficient between the edge section 9 and the SOI substrate 10 can be made small. Therefore, a thermal stress to be applied to the diaphragm 45 or the like can be suppressed small. That is, the temperature sensitivity of the pressure sensor 1 can be suppressed, and highly accurate pressure measurement can be achieved.

### Through-Hole Forming Step

The through-hole forming step is the same as in the production method described in the above-mentioned first embodiment. Therefore, the description of this step will be omitted.

### Release Etching Step

Subsequently, the SOI substrate 10 is exposed to an etching solution such as buffered hydrofluoric acid. By doing this, as shown in FIG. 25, a portion located below the diaphragm forming region 450 of the silicon oxide layer 10B is removed by etching through the plurality of through-holes 451. In this manner, a pressure reference chamber S is formed below the diaphragm forming region 450 and a wall section 3 in a frame shape is formed therearound. Further, by the pressure reference chamber S, the diaphragm forming region 450 is released from the silicon oxide layer 10B, and a portion overlapped with the pressure reference chamber S becomes the diaphragm 45.

Here, in this step, the edge section 9 functions as an etching stopper. Due to this, only a necessary portion of the silicon oxide layer 10B can be more reliably removed. Therefore, the pressure reference chamber S and the diaphragm 45 can be more easily formed into a desired shape.

### Sealing Step and Protective Film Forming Step

The sealing step and the protective film forming step are the same as in the production method described in the above-mentioned first embodiment. Therefore, the description of these steps will be omitted.

Also according to the second embodiment as described above, the same effect as that of the above-mentioned first embodiment can be exhibited.

### Third Embodiment

Next, a pressure sensor module according to a third embodiment of the invention will be described.

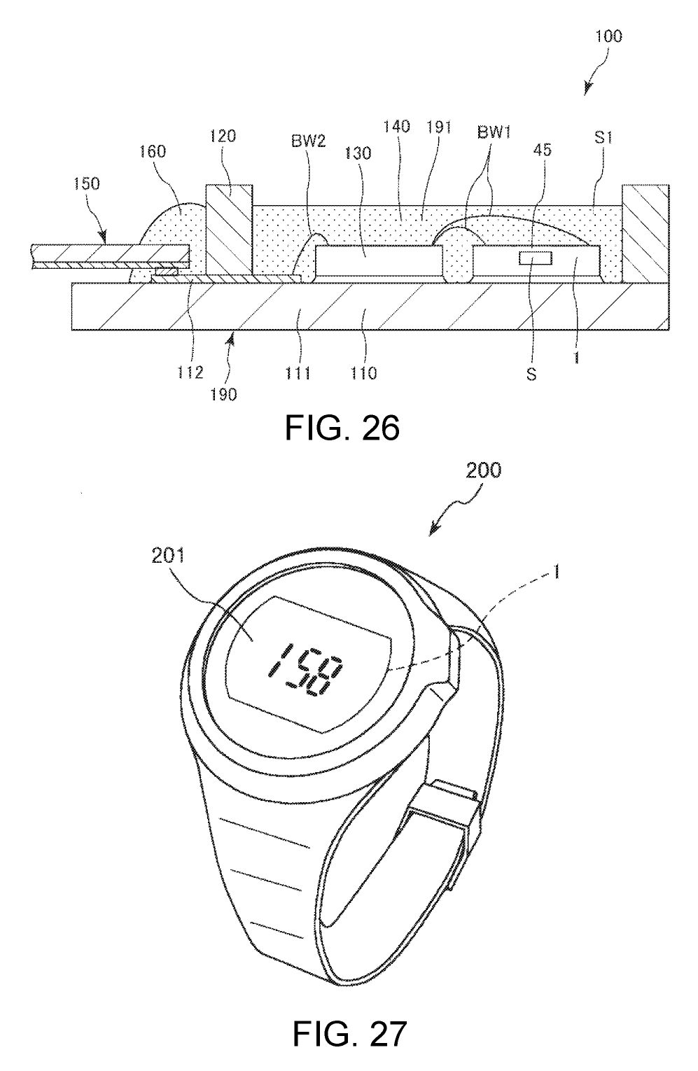

FIG. 26 is a cross-sectional view showing the pressure sensor module according to the third embodiment of the invention.

Hereinafter, with respect to the pressure sensor module according to the third embodiment, different points from the above-mentioned embodiments will be mainly described, and the description of the same matter will be omitted.

A pressure sensor module 100 shown in FIG. 26 includes a package 190 which is composed of a wiring board 110 and a wall section 120 in a frame shape that is placed on the upper surface of the wiring board 110, a pressure sensor 1 and a circuit element 130 which are housed in the package 190, a filling material 140 which is filled in the package 190 so as to cover the pressure sensor 1 and the circuit element 130, a flexible wiring board 150 which is electrically connected to the wiring board 110, and a sealing material 160 which covers a connection portion between the wiring board 110 and the flexible wiring board 150. As the pressure sensor 1, for example, the pressure sensors according to the above-mentioned respective embodiments can be used.

As the wiring board 110, for example, a known rigid wiring board in which a wiring 112 is placed in a substrate 111 composed of any of various resin materials such as a polyamide resin as a main material can be used. In the wiring board 110, on the upper surface of the substrate 111, the wiring 112 is placed inside and outside the wall section 120 so as to straddle the wall section. On such a wiring board 110, the wall section 120 in a frame shape is placed, and a recessed section 191 with a bottom formed from these members becomes a housing space S1 which houses the pressure sensor 1 and the circuit element 130. The constituent material of the wall section 120 is not particularly limited, and for example, various resin materials can be used.

On the upper surface of such a wiring board 110, the pressure sensor 1 and the circuit element 130 are placed side by side. According to this, the height of the pressure sensor module 100 can be lowered.

The circuit element 130 includes a drive circuit for supplying a voltage to a bridge circuit 50, a temperature compensation circuit for performing temperature compensation of an output from the bridge circuit 50, a pressure detection circuit which determines a pressure received from an output from the temperature compensation circuit, an output circuit which converts an output from the pressure detection circuit into a predetermined output form (CMOS, LV-PECL, LVDS, or the like) and outputs the converted output, and the like. Such a circuit element 130 is electrically connected to the pressure sensor 1 through a bonding wire BW1 and is electrically connected to the wiring 112 through a bonding wire BW2.

The filling material 140 is filled in the housing space S1 so as to cover the circuit element 130 and the pressure sensor 1. By such a filling material 140, the circuit element 130 and the pressure sensor 1 can be protected (protected from dust and moisture). Further, the filling material 140 is in a liquid form or a gel form. According to this, the circuit element 130 and the pressure sensor 1 can be effectively protected from moisture, and also a pressure can be efficiently transmitted to the pressure sensor 1 through the filling material 140. Such a filling material 140 is not particularly limited, and for example, a silicone oil, a fluorine-based oil, a silicone gel, or the like can be used.

The flexible wiring board 150 is electrically connected to the wiring 112 outside the housing space S1. By including such a flexible wiring board 150, electrical connection to an external device can be easily achieved. The connection portion between the flexible wiring board 150 and the wiring 112 is covered by the sealing material 160. According to this, the connection portion can be protected. The constituent material of the sealing material 160 is not particularly limited, however, a material with low elasticity is preferred, and for example, various resin materials such as an epoxy resin-based material, a polyimide resin-based material, a phenolic resin-based material, and a silicone resin-based material can be used.

Hereinabove, the pressure sensor module 100 has been described. Such a pressure sensor module 100 includes the pressure sensor 1 and the package 190 which houses the pressure sensor 1. Therefore, the pressure sensor 1 can be protected by the package 190. Further, the effect of the pressure sensor 1 described above can be enjoyed, and high reliability can be exhibited at low cost. The configuration of the pressure sensor module 100 is not limited to the above-mentioned configuration, and for example, the filling material 140 may be omitted.

### Fourth Embodiment

Next, an electronic apparatus according to a fourth embodiment of the invention will be described.

FIG. 27 is a perspective view showing an altimeter as the electronic apparatus according to the fourth embodiment of the invention.

As shown in FIG. 27, an altimeter 200 as the electronic apparatus can be worn on the wrist like a wristwatch. In the altimeter 200, the pressure sensor 1 is mounted, and the altitude of the current location above sea level, the atmospheric pressure at the current location, or the like can be displayed on a display section 201. In this display section 201, various information such as a current time, the heart rate of a user, and weather can be displayed. As the pressure sensor 1, for example, the pressure sensors according to the above-mentioned respective embodiments can be used.

Such an altimeter 200 which is one example of the electronic apparatus includes the pressure sensor 1. Therefore, the altimeter 200 can enjoy the effect of the pressure sensor 1 described above and can exhibit high reliability at low cost.

### Fifth Embodiment

Next, an electronic apparatus according to a fifth embodiment of the invention will be described.

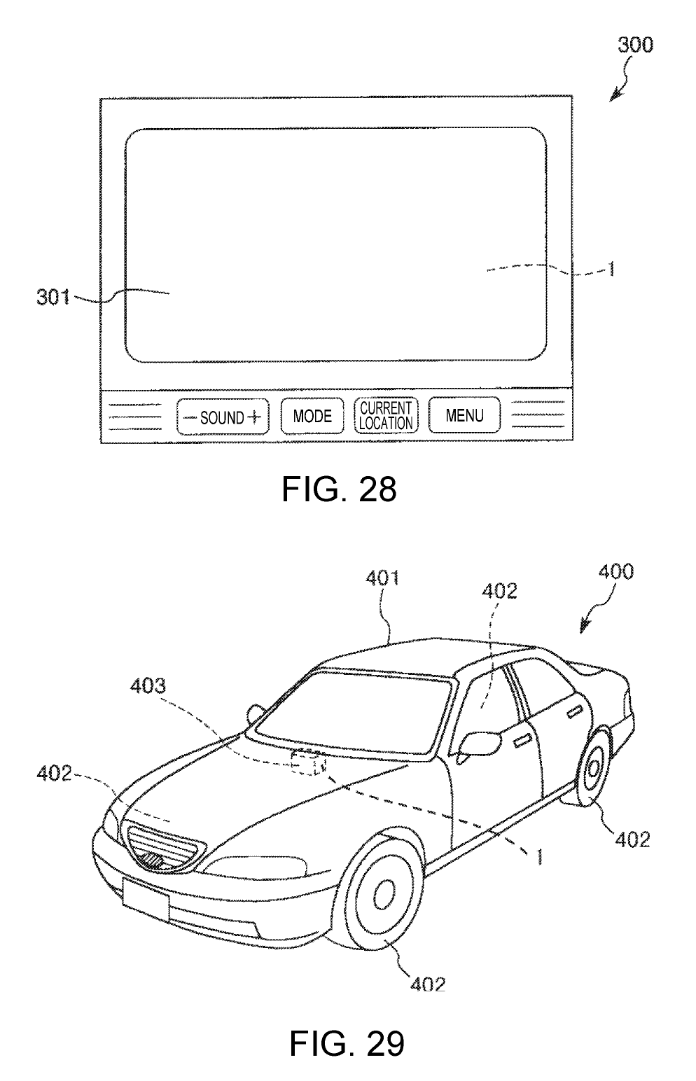

FIG. 28 is a front view showing a navigation system as the electronic apparatus according to the fifth embodiment of the invention.

As shown in FIG. 28, a navigation system 300 as the electronic apparatus includes map information (not shown), a location information acquisition unit based on a GPS (Global Positioning System), a self-contained navigation unit based on a gyroscope sensor, an accelerometer, and a vehicle speed data, the pressure sensor 1, and a display section 301 which displays given location information or route information. As the pressure sensor 1, for example, the pressure sensors according to the above-mentioned respective embodiments can be used.

According to this navigation system 300, in addition to the acquired location information, altitude information can be acquired. For example, in the case where a vehicle travels on an elevated road which is at substantially the same location as a general road in terms of location information, if altitude information is not included, a navigation system cannot determine whether the vehicle is traveling on the general road or on the elevated road and provides the user with information of the general road as priority information. Therefore, by mounting the pressure sensor 1 on the navigation system 300 and acquiring altitude information by the pressure sensor 1, the change in altitude due to entry into the elevated road from the general road can be detected, and the user can be provided with navigation information as to the traveling state on the elevated road.

Such a navigation system 300 as one example of the electronic apparatus includes the pressure sensor 1. Therefore, the navigation system 300 can enjoy the effect of the pressure sensor 1 described above and can exhibit high reliability at low cost.

The electronic apparatus according to the invention is not limited to the above-mentioned altimeter and navigation system, and can be applied to, for example, a personal computer, a digital still camera, a cellular phone, a smartphone, a tablet terminal, a timepiece (including a smart watch), a drone, medical apparatuses (for example, an electronic thermometer, a sphygmomanometer, a blood glucose meter, an electrocardiographic apparatus, an ultrasonic diagnostic apparatus, and an electronic endoscope), various types of measurement apparatuses, meters and gauges (for example, meters and gauges for vehicles, aircrafts, and ships), a flight simulator, and the like.

### Sixth Embodiment

Next, a vehicle according to a sixth embodiment of the invention will be described.

FIG. 29 is a perspective view showing a car as the vehicle according to the sixth embodiment of the invention.

As shown in FIG. 29, a car 400 as the vehicle includes a car body 401 and four wheels 402 (tires) and is configured to rotate the wheels 402 by a power source (engine) (not shown) provided in the car body 401. Further, the car 400 includes an electronic control unit (ECU) 403 mounted on the car body 401 and the pressure sensor 1 is built in this electronic control unit 403. The electronic control unit 403 ascertains the traveling state, posture, etc. of the car by detecting the acceleration, inclination, etc. of the car body 401 by the pressure sensor 1, and therefore can accurately control the wheels 402 or the like. According to this, the car 400 can safely and stably travel. As the pressure sensor 1, for example, the pressure sensors according to the above-mentioned respective embodiments can be used. The pressure sensor 1 may also be mounted on a navigation system or the like included in the car 400.

Such a car 400 as one example of the vehicle includes the pressure sensor 1. Therefore, the car 400 can enjoy the effect of the pressure sensor 1 described above and can exhibit high reliability.

Hereinabove, the pressure sensor, the production method for a pressure sensor, the pressure sensor module, the electronic apparatus, and the vehicle according to the invention have been described based on the respective embodiments shown in the drawings, however, the invention is not limited thereto, and the configuration of each section can be replaced with an arbitrary configuration having the same function. Further, another arbitrary component or step may be added. In addition, the respective embodiments may be appropriately combined with each other.

For example, by arranging the pressure sensors 1 according to the first embodiment in a matrix, the resulting material can be used as a tactile sensor. In such a case, by detecting a pressure received by pressing for each pressure sensor, the contact place and contact intensity can be specified, and by adding up these, a pressure distribution can be generated.

The entire disclosure of Japanese Patent Application No. 2017-137015, filed Jul. 13, 2017 is expressly incorporated by reference herein.

What is claimed is:

1. A pressure sensor, comprising:
a semiconductor substrate;
an insulating layer which is placed on one surface of the semiconductor substrate and is provided with a cavity section; and
a semiconductor layer which is placed on the opposite side to the semiconductor substrate of the insulating layer and includes a diaphragm that is placed so as to cover the cavity section.

2. The pressure sensor according to claim 1, wherein
the diaphragm includes a through-hole which communicates with the cavity section and has a sealing section which seals the through-hole.

3. The pressure sensor according to claim 2, wherein in a plan view of the semiconductor substrate, a plurality of through-holes are placed along the outer edge of the diaphragm.

4. The pressure sensor according to claim 1, wherein the pressure sensor has a piezoresistive element placed in the diaphragm.

5. The pressure sensor according to claim 1, wherein the pressure sensor has an edge section which is placed on an inner circumferential surface facing the cavity section of the insulating layer and surrounds at least a part of the cavity section in a plan view of the semiconductor substrate.

6. The pressure sensor according to claim 1, wherein
the semiconductor substrate contains silicon,
the insulating layer contains silicon oxide, and
the semiconductor layer contains silicon.

7. A production method for a pressure sensor, comprising:
preparing an SOI substrate which has a first silicon layer, a second silicon layer, and an oxide silicon layer located between the first silicon layer and the second silicon layer;
placing a piezoresistive element on the second silicon layer;
forming a through-hole which penetrates the second silicon layer in the thickness direction and faces the silicon oxide layer;
forming a cavity section which is located between the first silicon layer and the second silicon layer and a diaphragm which faces the first silicon layer through the cavity section, includes the piezoresistive element, and is flexurally deformed by receiving a pressure by removing a part of the silicon oxide layer through the through-hole; and
sealing the through-hole.

8. The production method for a pressure sensor according to claim 7, wherein
the sealing includes
forming a sealing layer on the surface on the opposite side to the first silicon layer of the diaphragm, and
thinning the sealing layer.

9. The production method for a pressure sensor according to claim 8, wherein the sealing layer is formed by high-density plasma CVD.

10. The production method for a pressure sensor according to claim 9, wherein the sealing layer contains silicon oxide.

11. A pressure sensor module, comprising:
the pressure sensor according to claim 1; and
a package which houses the pressure sensor.

12. A pressure sensor module, comprising:
the pressure sensor according to claim 2; and
a package which houses the pressure sensor.

13. A pressure sensor module, comprising:
the pressure sensor according to claim 3; and
a package which houses the pressure sensor.

14. A pressure sensor module, comprising:
the pressure sensor according to claim 4; and
a package which houses the pressure sensor.

15. An electronic apparatus, comprising the pressure sensor according to claim 1.

16. An electronic apparatus, comprising the pressure sensor according to claim 2.

17. An electronic apparatus, comprising the pressure sensor according to claim 3.

18. A vehicle, comprising the pressure sensor according to claim 1.

19. A vehicle, comprising the pressure sensor according to claim 2.

20. A vehicle, comprising the pressure sensor according to claim 3.
